(19) United States
(12) Patent Application Publication
(10) Pub. No.: US 2023/0261172 A1
(43) Pub. Date: Aug. 17, 2023

(54) SOLID -STATE BATTERY SYSTEM INCLUDING A GRAPHITE ANODE

(71) Applicant: GM GLOBAL TECHNOLOGY OPERATIONS LLC, Detroit, MI (US)

(72) Inventors: Zhe Li, Anda (CN); Qili Su, Shanghai (CN); Yong Lu, Shanghai (CN); Meiyuan Wu, Pudong, Shanghai (CN); Haijing Liu, Shanghai (CN)

(73) Assignee: GM GLOBAL TECHNOLOGY OPERATIONS LLC, Detroit, MI (US)

(21) Appl. No.: 17/851,095

(22) Filed: Jun. 28, 2022

(30) Foreign Application Priority Data
Feb. 16, 2022 (CN) CN202210141858.4

(51) Int. Cl. H01M 4/133; H01M 4/36; H01M 4/587; H01M 10/0562; H01M 10/0525

(52) U.S. Cl. CPC H01M 4/133; H01M 4/366; H01M 4/587; H01M 10/0525; H01M 10/0562; H01M 2004/021

(57) ABSTRACT

A solid-state battery system including a graphite anode is provided. The system includes a battery cell. The battery cell includes the graphite anode, a cathode, and a solid electrolyte layer. The graphite anode includes a plurality of graphite particles, wherein the plurality of graphite particles includes a first portion of the plurality of graphite particles including a plurality of relatively high specific surface area graphite particles and a second portion of the plurality of graphite particles including a plurality of relatively low specific surface area graphite particles. The solid electrolyte layer is disposed between the graphite anode and the cathode and is operable to provide lithium-ion conduction path between the graphite anode and the cathode.

### CROSS REFERENCE TO RELATED APPLICATIONS

This disclosure claims priority to China Patent Application CN202210141858.4 filed on Feb. 16, 2022, which is hereby incorporated by reference.

### INTRODUCTION

The disclosure generally relates to a solid-state battery system including a graphite anode.

Battery cells may include an anode, a cathode, and an electrolyte. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A solid-state battery cell includes a solid electrolyte layer or film which provides lithium-ion conduction paths between the anode and the cathode. The solid electrolyte is a solid ionic conductor. The solid electrolyte is additionally an electronically insulating material. Particles of the solid electrolyte material may additionally be mixed or blended with materials of both the solid anode active particle and the solid cathode active particle.

### SUMMARY

A solid-state battery system including a graphite anode is provided. The system includes a battery cell. The battery cell includes the graphite anode, a cathode, and a solid electrolyte layer or film. The graphite anode includes a plurality of graphite particles, wherein the plurality of graphite particles includes a first portion of the plurality of graphite particles including a plurality of relatively high specific surface area graphite particles and a second portion of the plurality of graphite particles including a plurality of relatively low specific surface area graphite particles. The solid electrolyte layer or film is disposed between the graphite anode and the cathode and is operable to provide lithium-ion conduction paths between the graphite anode and the cathode.

In some embodiments, the plurality of the relatively high specific surface area graphite particles include a specific surface area of between 3.0 meters squared per gram and 5.0 meters squared per gram.

In some embodiments, the plurality of the relatively high specific surface area graphite particles include a specific surface area of 4.0 meters squared per gram.

In some embodiments, the plurality of the relatively low specific surface area graphite particles include a specific surface area of between 1.0 meters squared per gram and 2.0 meters squared per gram.

In some embodiments, the plurality of the relatively low specific surface area graphite particles include a specific surface area of 1.5 meters squared per gram.

In some embodiments, a ratio of the first portion to the second portion by weight is between 5:95 and 95:5.

In some embodiments, a ratio of the first portion to the second portion by weight is 1:1.

In some embodiments, the graphite anode further includes a first layer including the plurality of the relatively high specific surface area graphite particles and a second layer including the plurality of the relatively low specific surface area graphite particles. The second layer is disposed between the first layer and the solid electrolyte layer.

In some embodiments, the graphite anode further includes a first layer including the plurality of the relatively high specific surface area graphite particles and a second layer including the plurality of the relatively low specific surface area graphite particles. The first layer is disposed between the second layer and the solid electrolyte layer.

In some embodiments, the battery cell further includes a gel electrolyte which is operable to build up favorable lithium-ion conduction paths between solid-solid contacts in the graphite anode.

In some embodiments, a weight of the gel electrolyte is 10% of a total weight of anode.

In some embodiments, the solid electrolyte layer is one of an oxide-based solid electrolyte layer, a metal-doped solid electrolyte layer, an aliovalent-substituted oxide solid electrolyte layer, a sulfide-based solid electrolyte layer, a nitride-based solid electrolyte layer, a hydride-based solid electrolyte layer, a halide-based solid electrolyte layer, or a borate-based solid electrolyte layer.

In some embodiments, the cathode includes a cathode active material, solid electrolyte particles, a conductive additive, a binder, and a portion of the gel electrolyte.

In some embodiments, the cathode active material includes one of a rock salt layered oxide, a spinel, a polyanion cathode, a surface-coated cathode material, a doped cathode material, a lithiated metal oxide, a lithiate metal sulfide.

In some embodiments, the gel electrolyte includes a polymer host and a liquid electrolyte.

In some embodiments, the liquid electrolyte includes a lithium salt and a solvent. The solvent includes one of a carbonate solvent, a lactone, a nitrile, a sulfone, an ether, a phosphate, or an ionic liquid.

In some embodiments, the system further includes a plurality of battery cells, wherein the battery cells are connected as one of a monopolar cell or a bipolar cell.

According to one alternative embodiment, a solid-state battery system including a graphite anode is provided. The system includes a battery cell. The battery cell includes the graphite anode, a cathode, and a solid electrolyte layer or film. The graphite anode includes a plurality of graphite particles, wherein the plurality of graphite particles includes a first portion of the plurality of graphite particles including a plurality of relatively high specific surface area graphite particles and a second portion of the plurality of graphite particles including a plurality of relatively low specific surface area graphite particles. The solid electrolyte layer or film is disposed between the graphite anode and the cathode and is operable to provide lithium-ion conduction paths between the graphite anode and the cathode. The cathode and the anode each include solid electrolyte particles including one of an oxide-based solid electrolyte, a metal-doped solid electrolyte, an aliovalent-substituted oxide solid electrolyte, a sulfide-based solid electrolyte, a nitride-based solid electrolyte, a hydride-based solid electrolyte, a halide-based solid electrolyte layer, or a borate-based solid electrolyte. The cathode and anode each further include a conductive additive including one of carbon black, graphene, graphene oxide, acetylene black, carbon nanofibers, and carbon nanotubes. The cathode and anode each further include a binder material including one of poly(vinylidene fluoride), poly(vinylidene fluoride-co-hexafluoropropylene), poly(tetrafluoroethylene), sodium carboxymethyl cellulose, styrene-butadiene rubber, nitrile butadiene rubber, and styrene ethylene butylene styrene copolymer.

According to one alternative embodiment, a solid-state battery system including a graphite anode is provided. The system includes a battery cell. The battery cell includes the graphite anode, a cathode, and a solid electrolyte layer or film. The graphite anode includes a plurality of graphite particles, wherein the plurality of graphite particles includes a first portion of the plurality of graphite particles including a plurality of relatively high specific surface area graphite particles and a second portion of the plurality of graphite particles including a plurality of relatively low specific surface area graphite particles. The solid electrolyte layer or film is disposed between the graphite anode and the cathode and is operable to provide lithium-ion conduction paths between the graphite anode and the cathode. The graphite anode further includes other anode active material including one of a carbonaceous material, a silicon, a silicon mixed with graphite, or transition metal, a metal oxide, or a metal sulfide. The graphite anode further includes a conductive additive including one of carbon black, graphene, graphene oxide, acetylene black, carbon nanofibers, and carbon nanotubes. The graphite anode further includes a binder material including one of poly(vinylidene fluoride), poly(vinylidene fluoride-co-hexafluoropropylene), poly(tetrafluoroethylene), sodium carboxymethyl cellulose, styrene-butadiene rubber, nitrile butadiene rubber, and styrene ethylene butylene styrene copolymer.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary solid-state battery cell, including a graphite anode including a graphite blend, in accordance with the present disclosure;

FIG. 2 schematically illustrates in cross section a portion of the battery cell of FIG. 1, in accordance with the present disclosure;

FIG. 3 schematically illustrates in cross section an alternative exemplary battery cell including a dual layer graphite configuration, in accordance with the present disclosure;

FIG. 4 schematically illustrates in cross section an additional alternative exemplary battery cell including a dual layer graphite configuration, in accordance with the present disclosure;

FIG. 5 illustrates an exemplary stack of battery cells configured in monopolar cell stacking, in accordance with the present disclosure;

FIG. 6 illustrates an exemplary stack of battery cells configured in bipolar cell stacking, in accordance with the present disclosure;

FIG. 7 is a graph illustrating low temperature discharge performance of a battery cell including a graphite anode including relatively high specific surface area graphite particles vs. a graphite anode including a battery cell including a blend of graphite particles, in accordance with the present disclosure;

FIG. 8 is a graph illustrating high temperature durability of a battery cell including a graphite anode including relatively high specific surface area graphite particles vs. a graphite anode including a battery cell including a blend of graphite particles as disclosed herein, the graph illustrating capacity retention vs. high temperature aging cycles, in accordance with the present disclosure;

FIG. 9 is a graph illustrating high temperature durability of a battery cell including a graphite anode including relatively high specific surface area graphite particles vs. a graphite anode including a battery cell including a blend of graphite particles as disclosed herein, the graph illustrating cell voltage vs. high temperature aging cycles, in accordance with the present disclosure; and

FIG. 10 is a graph illustrating direct current resistance versus battery cycles of a battery cell including a graphite anode including relatively high specific surface area graphite particles vs. a graphite anode including a battery cell including a blend of graphite particles as disclosed herein, in accordance with the present disclosure.

### DETAILED DESCRIPTION

A solid-state battery may include a graphite anode. A solid-state battery may include an exemplary LiMn_{0.7}Fe_{0.3}PO₄ cathode. A solid-state battery may include an exemplary Li₇La₃Zr₂O₁₂ (LLZO) solid electrolyte layer. A solid-state battery may additionally include a gel polymer electrolyte (e.g., Poly(vinylidene fluoride-hexafluoropropylene (PVDF-HFP) with liquid electrolyte (0.4 M LiTFSI + 0.4 M LiBF₄ + 2.5 wt% LiBOB in EC/GBL=4:6 (w/w)).

Graphite particles may occur or be produced in different sizes which have different resulting specific surface areas. In one embodiment, a relatively larger graphite particle may be described to include a low-specific surface area. An exemplary low-specific surface area for a graphite particle may be 1.5 m²/g. A relatively smaller graphite particle may be described to include a high-specific surface area. An exemplary high-specific surface area for a graphite particle may be 4.0 m²/g. Graphite particle size may affect operation and efficiency of the associated battery cell. In one exemplary embodiment, relatively smaller graphite particles may be desirable in an anode due to improved operation of the anode at lower temperatures. Such relatively smaller graphite particles provide excellent ionic gel-graphite interfaces or a high interfacial contact area, assuming the gel has fully covered pores of the graphite.

A solid electrolyte interphase (SEI) may form upon a surface of an anode. An SEI results from a chemical reaction between the anode and a liquid or gel electrolyte interacting with the anode. The SEI forms as a film upon the anode. Where the anode is a graphite anode, the surface of the anode includes a plurality of graphite particles. The size of the graphite particles defines a surface area for the anode. When the anode includes a larger number of relatively smaller particles, the resulting relatively high surface area resulting in the anode results in a relatively larger SEI buildup. When the anode includes a larger number of relatively larger particles, the resulting relatively low surface area resulting in the anode results in a relatively smaller SEI buildup. In one embodiment, by utilizing a blend of graphite particles including relatively small graphite particles and relatively large graphite particles may reduce a total gel-graphite contact area by 31.25% as compared to using graphite particles including exclusively relatively small graphite particles.

Excessive SEI buildup reduces battery capacity and results in lower efficiency in both charging and discharging cycles. SEI buildup resulting from high-temperature cycling (e.g., cycling at 45° C.) may cause a loss of active lithium and cause accelerated cell resistance.

A solid-state battery system including a graphite anode is provided. The graphite anode includes a mixture of relatively larger graphite particles and relatively smaller graphite particles. Testing has shown that an anode including at least a threshold portion of relatively smaller graphite particles may exhibit enhanced low temperature or cold-cranking capability. Testing has shown that the same anode including a least a threshold portion of relatively larger graphite particles may inhibit excessive SEI buildup and may suppress continuous loss of active lithium and decelerate a cell resistance increase that results during high-temperature cycling. One may describe such an anode construction as an interfacial design strategy developed to reduce the total ionic contact area between gel and graphite active material by incorporating low-specific surface area graphite into high-specific surface area graphite.

In one example, the graphite anode may include a blend of graphite particles as described herein / lithium lanthanum zirconium oxide (LLZO) / carbon additives / binder = (85~97 wt%): (1-10 wt%): (1-6 wt%): (1-6 wt%). According to one embodiment, the graphite anode may include a weight ratio of 93: 1: 2: 4 of the above-described components.

Relatively smaller graphite particles or graphite particles with a large specific surface area as described herein for the blend of graphite materials may include a specific surface area of 3.0 to 5.0 meters squared per gram. In one embodiment, the relatively small graphite particles may include a specific surface area of 4.0 meters squared per gram. The relatively smaller graphite particles may be described as single particles with amorphous carbon coatings and may include a 1 C capacity of 335 mAh/g. The C-rate represents the rate at which level the battery is providing energy. 1 C means that the battery is fully charged or discharged within one hour, 2 C is 30 minutes, and so on. In this case, it means, the battery can be charged at 335 mAh/g within one hour. Relatively larger graphite particles or graphite particles with a small specific surface area as described herein for the blend of graphite materials may include a specific surface area of 1.0 to 2.0 meters squared per gram. In one embodiment, the relatively small graphite particles may include a specific surface area of 1.5 meters squared per gram. The relatively larger graphite particles may be described as secondary structures with amorphous carbon modification and may include a 1 C capacity of 351 mAh/g. In one example, the graphite anode may include a blend of graphite particles including between 5% and 95% by weight of relatively high-specific-surface-area graphite particles and between 5% and 95% by weight of relatively low-specific-surface-area graphite particles. In one embodiment, relatively high-specific-surface-area graphite particles and relatively low-specific-surface-area graphite particles may be present in the blend of graphite particles in a 1:1 ratio by weight.

Intermediate or relatively moderately-specific-surface-area graphite particles may be defined to include graphite particles with a specific surface area between 2.0 and 3.0. The intermediate graphite particles may be described as single particles with amorphous carbon coatings and may include a 1 C capacity of 343 mAh/g. Such intermediate graphite particles may be present as some portion of the blend of graphite particles, although such particles do not contribute to the enhanced low temperature operation enabled by the defined smaller graphite particles and such particles do not contribute to resist SEI formation, suppress continuous loss of active lithium, and decelerate a cell resistance increase as effectively as the defined larger graphite particles. Presence of such intermediate particles does not negate the benefits of the disclosed blend of graphite particles. In one embodiment, presence of the defined smaller graphite particles and the defined larger graphite particles may be optimized or maximized, while presence of intermediate graphite particles may be minimized or eliminated.

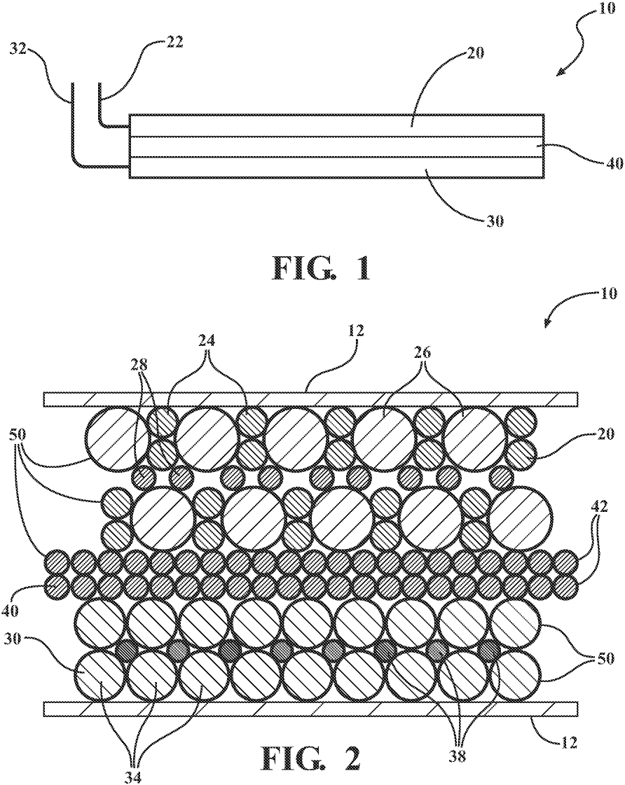

Referring now to the drawings, wherein like reference numbers refer to like features throughout the several views, FIG. 1 schematically illustrates an exemplary solid-state battery cell 10, including a graphite anode 20 including a graphite blend as described in the present disclosure. The battery cell 10 is illustrated further including cathode 30 and solid electrolyte layer or film 40. The battery cell 10 enables converting electrical energy into stored chemical energy in a charging cycle, and the battery cell enables converting stored chemical energy into electrical energy in a discharging cycle. A negative electrical lead 22 and a positive electric lead 32 are illustrated connected to the anode 20 and the cathode 30, respectively. Battery cell 10 provides electrical energy through the negative electrical lead 22 and the positive electrical lead 32. A plurality of battery cells 10 may be provided in series and/or in parallel to deliver electrical energy to a connected system.

The solid electrolyte layer or film 40 may include a number of different materials. Exemplary solid electrolyte materials include an oxide-based solid electrolyte, a metal-doped solid electrolyte, an aliovalent-substituted oxide solid electrolyte, a sulfide-based solid electrolyte, a nitride-based solid electrolyte, a hydride-based solid electrolyte, a halide-based solid electrolyte, or a borate-based solid electrolyte.

The cathode 30 may include a cathode active material, a solid electrolyte or solid electrolyte particles, a conductive additive, a binder, and a gel electrolyte. The cathode 30, in one exemplary embodiment, is between 5 micrometers and 400 micrometers thick.

In one embodiment, a gel electrolyte is utilized to build up favorable lithium-ion conduction paths between solid-solid contacts in the anode 20. The content of the gel may be between 0 and 30% by weight, wherein the anode thickness is approximately between 5 micrometers and 400 micrometers. The graphite active material may further include one of the following: carbonaceous material (e.g., hard carbon or soft carbon), silicon or silicon mixed with graphite (SiOₓ, Li SiOₓ), or transition metal (e.g., tin) metal oxide/sulfide (e.g., TiO₂, FeS, or similar substances), and other lithium accepting anode materials.

The gel electrolyte may be present in a trace amount, or the gel electrolyte may be present in significantly higher quantity than the solid electrolyte. In one embodiment, a weight of the gel electrolyte may be 10% of a total weight of anode. In combination with the gel electrolyte, the solid electrolyte may be one of an oxide-based solid electrolyte, a metal-doped solid electrolyte, an aliovalent-substituted oxide solid electrolyte, a sulfide-based solid electrolyte, a nitride-based solid electrolyte, a hydride-based solid electrolyte, a halide-based solid electrolyte, or a borate-based solid electrolyte.

The gel electrolyte may include a polymer host (0.1%~50% (by weight)) and a liquid electrolyte (5%~90% (by weight)). The polymer host may include one or more of poly(ethylene oxide)s, poly(vinylidene fluoride-co-hexafluoropropylene)s, poly(methyl methacrylate)s, carboxymethyl cellulose, polyacrylonitrile, polyvinylidene difluoride, poly(vinyl alcohol), or polyvinylpyrrolidone.

The gel electrolyte may include a lithium salt and a solvent. The lithium salt includes a lithium cation and may include one of more of hexafluoroarsenate; hexafluorophosphate; bis(fluorosulfonyl)imide; perchlorate; tetrafluoroborate; cyclo-difluoromethane-1,1-bis(sulfonyl)imide; bis(trifluoromethanesulfonyl)imide; bis(perfluoroethanesulfonyl)imide; bis(oxalate)borate; difluoro(oxalato)borate; and bis(fluoromalonato)borate. The solvent dissolves the lithium salt enabling excellent lithium-ion conductivity. Additionally, the solvent may be selected based upon a relatively low vapor pressure in accordance with a typical fabrication process. The solvent may be selected from one of a carbonate solvent, a lactone, a nitrile, a sulfone, an ether, a phosphate, or an ionic liquid.

A conductive additive may be provided in anode 20 and/or the cathode 30 including one of the following: carbon black, graphene, graphene oxide, Super P®, acetylene black, carbon nanofibers, carbon nanotubes, and other similar electronically conductive additives.

Binder materials may be used in the anode 20 and/or the cathode 30 including one of the following: poly(vinylidene fluoride) (PVDF); poly(vinylidene fluoride-co-hexafluoropropylene) (PVDF-HFP); poly(tetrafluoroethylene) (PTFE); sodium carboxymethyl cellulose (CMC); styrene-butadiene rubber (SBR); nitrile butadiene rubber (NBR); and styrene ethylene butylene styrene copolymer (SEBS).

FIG. 2 schematically illustrates in cross section a portion of the battery cell 10 of FIG. 1. The battery cell is illustrated including the anode 20 including a layer or film, the cathode 30 including a layer or film, and the solid electrolyte layer 40 including a layer or film. Additionally, a gel electrolyte 50 is illustrated as a film coating on the surface (or within pores of) of the anode 20, the cathode 30, and the solid electrolyte layer 40. The battery cell 10 is illustrated further including a current collector 12. Each of the anode 20, the cathode 30, and the solid electrolyte layer 40 are illustrated as layers of exemplary particles. The provided circular shapes are intended to provide an explanation of the particles that make up the various layers and the relative sizes of the portions of the graphite particles of the anode to each other. The particles are illustrated as circles for simplicity sake, and the actual particles may be of a variety of actual shapes. The anode 20, the cathode 30, and the solid electrolyte layer 40 may each include thousands of respective particles.

The cathode 30 is illustrated including a plurality of cathode particles 34 as disclosed herein, including materials selected based upon desired operation of the cathode 30 within the battery cell. Additionally, a plurality of solid electrolyte particles 38 are illustrated interspersed between the cathode particles 34. In one embodiment, the cathode 30 may be constructed with the electrolyte particles 38 disposed therewithin. The electrolyte particles 38 may include a same or a different material as compared to the material of the solid electrolyte layer 40. The solid electrolyte layer 40 is illustrated including a plurality of solid electrolyte particles 42.

The anode 20 is illustrated including a blend of graphite particles. The blend includes a plurality of relatively high specific surface area particles 24 and a plurality of relatively low specific surface area particles 26. The relatively high specific surface area particles 24 are smaller in size than the relatively low specific surface area particles 26. As described herein, inclusion of the relatively high specific surface area particles 24 improves or provides excellent operation, in particular, in low temperature condition. As additionally described herein, inclusion of the relatively low specific surface area particles 26 decreases an overall surface area of the particles within the anode 20, inhibits excessive SEI growth, and enhance high-temperature performance upon the anode 20 as compared to an anode including exclusively relatively high specific surface area graphite particles 24. In one embodiment, the anode 20 may be constructed with the electrolyte particles 28 disposed therewithin.

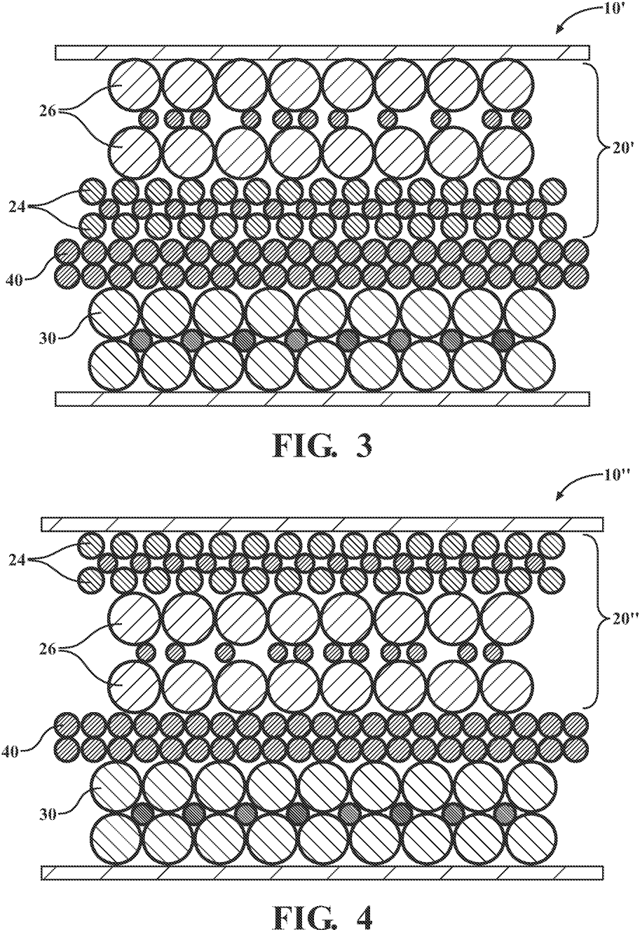

FIG. 3 schematically illustrates in cross section an alternative exemplary battery cell 10′ including a dual layer graphite configuration. The battery cell 10′ is illustrated including an anode 20′, a cathode 30, and a solid electrolyte layer or film 40. The battery cell 10′ is similar to the battery cell 10 of FIG. 2, with an exception that the anode 20′ includes a first distinct layer of relatively high specific surface area particles 24 and a second distinct layer of relatively low specific surface area particles 26. In the embodiment of FIG. 3, the first distinct layer of relatively high specific surface area particles 24 is disposed adjacent to the solid electrolyte layer or film 40, and the second distinct layer of relatively low specific surface area particles 26 is separated from the solid electrolyte layer or film 40 by the first distinct layer of relatively high specific surface area particles 24.

FIG. 4 schematically illustrates in cross section an additional alternative exemplary battery cell 10″ including a dual layer graphite configuration. The battery cell 10″ is illustrated including an anode 20″, a cathode 30, and a solid electrolyte layer or film 40. The battery cell 10″ is similar to the battery cell 10 of FIG. 2, with an exception that the anode 20″ includes a first distinct layer of relatively high specific surface area particles 24 and a second distinct layer of relatively low specific surface area particles 26. In the embodiment of FIG. 4, the second distinct layer of relatively low specific surface area particles 26 is disposed adjacent to the solid electrolyte layer or film 40, and the first distinct layer of relatively high specific surface area particles 24 is separated from the solid electrolyte layer or film 40 by the second distinct layer of relatively low specific surface area particles 26. The layered configurations illustrated in FIGS. 3 and 4 may affect lithium-ion transportation within the anode layer, which may enhance the power performance of the cell.

FIG. 5 illustrates an exemplary stack 70 of battery cells 10A, 10B, and 10C configured in a monopolar cell stacking configuration. A first battery cell 10A is illustrated including an anode 20A, a cathode 30A, and a solid electrolyte layer or film 40. A second battery cell 10B is illustrated including an anode 20B, a cathode 30B, and a solid electrolyte layer or film 40. A third battery cell 10C is illustrated including an anode 20C, a cathode 30C, and a solid electrolyte layer or film 40. The anode 20A, the anode 20B, and the anode 20C may be electrically connected together to form a common negative terminal. The cathode 30A, the cathode 30B, and the cathode 30C may be electrically connected together to form a common positive terminal. The stack 70 may include a common conductive element 72 disposed between the anode 20A and the anode 20B, such that an electrical connection may be made to both the anode 20A and the anode 20B through electrical connection to the common conductive element 72. The stack 70 may further include a common conductive element 74 disposed between the cathode 30B and the cathode 30C, such that an electrical connection may be made to both the cathode 30B and the cathode 30C through electrical connection to the common conductive element 74.

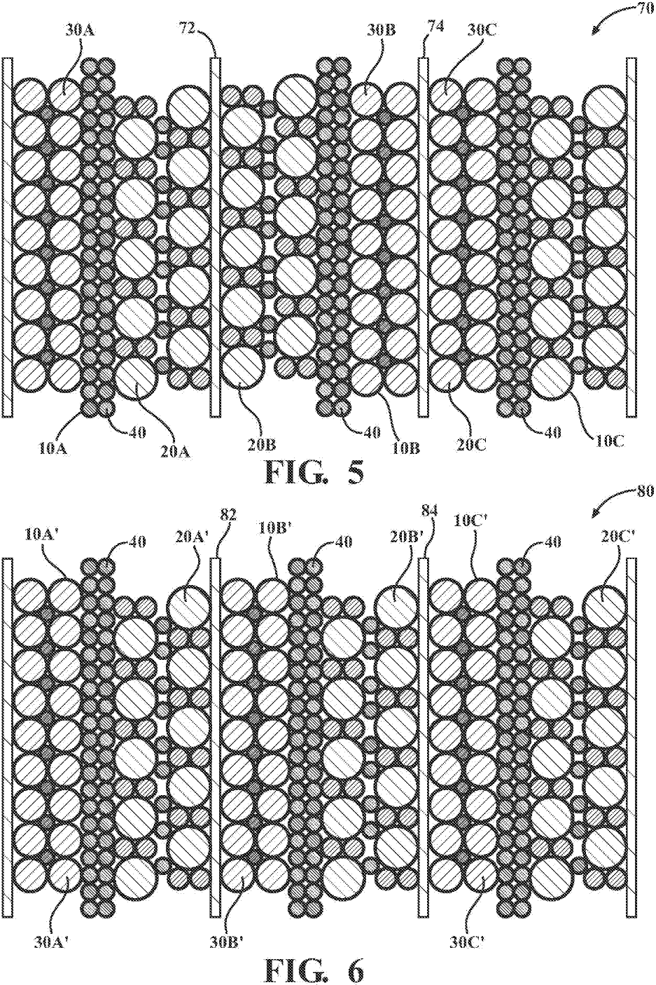

FIG. 6 illustrates an exemplary stack 80 of battery cells 10A′, 10B′, and 10C′ configured in a bipolar cell stacking configuration. A first battery cell 10A′ is illustrated including an anode 20A′, a cathode 30A′, and a solid electrolyte layer 40. A second battery cell 10B′ is illustrated including an anode 20B′, a cathode 30B′, and a solid electrolyte layer 40. A third battery cell 10C′ is illustrated including an anode 20C′, a cathode 30C′, and a solid electrolyte layer 40. The anode 20A′ may be electrically connected to the cathode 30B′, thereby connecting the battery cells 10A′ and 10B′ in series. The anode 20B′ may be electrically connected to the cathode 30C′, thereby connecting the battery cells 10B′ and 10C′ in series. The stack 80 may include a common conductive element 82 disposed between the anode 20A′ and the cathode 30B′, such that an electrical connection may be made between the anode 20A′ and the cathode 30B′ through the common conductive element 82. The stack 80 may further include a common conductive element 84 disposed between the anode 20B′ and the cathode 30C′, such that an electrical connection may be made between the anode 20B′ and the cathode 30C′ through the common conductive element 84.

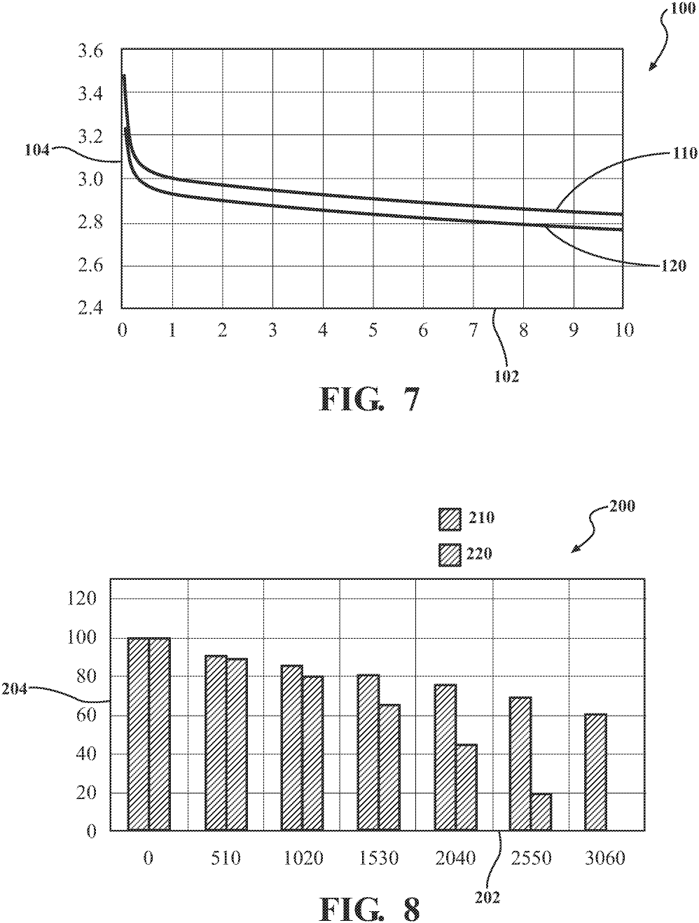

FIG. 7 is a graph 100 illustrating low temperature discharge performance of a battery cell including a graphite anode including relatively high specific surface area graphite particles vs. a graphite anode including a battery cell including a blend of graphite particles as disclosed herein. The graph 100 illustrates cold cranking testing results performed under 10 C current rate. The graph 100 illustrates time in seconds on horizontal axis 102 and voltage in Volts on vertical axis 104. Plot 120 illustrates performance of a LMFP+LMO (lithium manganese iron phosphate + lithium-ion manganese) / graphite pouch cell, wherein the graphite anode includes exclusively relatively high specific surface area (4.0 m²/g) graphite particles. Plot 110 illustrates performance of a similar LMFP+LMO / graphite pouch cell, wherein the graphite anode includes a blend of relatively high specific surface area (4.0 m²/g) graphite particles and relatively low specific surface area (1.5 m²/g) graphite particles at a 1:1 ratio. Plot 110 illustrates improved cold cranking performance of the battery cell including the graphite blend as compared to the battery cell including exclusively the relatively high specific surface area graphite particles.

FIG. 8 is a graph 200 illustrating high temperature durability of a battery cell including a graphite anode including relatively high specific surface area graphite particles vs. a graphite anode including a battery cell including a blend of graphite particles as disclosed herein, the graph 200 illustrating capacity retention vs. high temperature aging cycles. Graph 200 illustrates high temperature (45 C) aging cycles on horizontal axis 202 and capacity retention as a percentage on vertical axis 204. Graph 200 includes a plurality of bars 220 representing percentage capacity versus a number of aging cycles for a battery cell including a graphite anode with exclusively relatively high specific surface area graphite particles. Graph 200 further includes a plurality of bars 210 representing percentage capacity versus the number of aging cycles for a battery cell including a graphite anode with a blend of graphite particles including relatively high specific surface area graphite particles and relatively low specific surface area graphite particles. Graph 200 illustrates that the graphite anode including a blend of graphite particles provides increased capacity retention over the graphite anode including exclusively relatively high specific surface area graphite particles through a series of high temperature aging cycles.

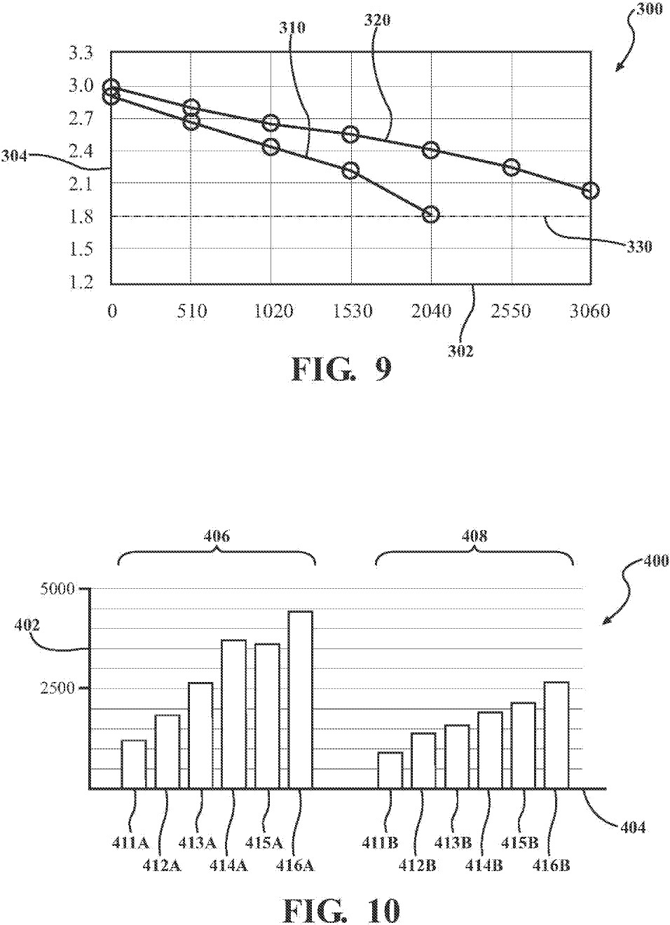

FIG. 9 is a graph 300 illustrating high temperature durability of a battery cell and resulting cold cranking voltage. The graph 300 illustrates high temperature (45 C) aging cycles on horizontal axis 302 and cell voltage available for cold cranking for a two second pulse on vertical axis 304. The battery cell includes a graphite anode. Performance is compared between the graphite anode including exclusively relatively high specific surface area graphite particles, represented by plot 310 vs. the graphite anode including a blend of graphite particles as disclosed herein, represented by plot 320. A horizontal line 330 is illustrated to demark a minimum 1.8 Volts useful for performing a cranking operation. The graph 300 illustrates improved cold cranking performance retention over high temperature aging cycles for an anode including the blend of graphite particles disclosed herein as compared to an anode including exclusively relatively high specific surface area graphite particles.

FIG. 10 is a graph 400 illustrating direct current resistance versus battery cycles of a battery cell including a graphite anode including relatively high specific surface area graphite particles vs. a graphite anode including a battery cell including a blend of graphite particles as disclosed herein. The graph 400 illustrates a number of aging cycles incurred by a test battery cell for a particular test value on horizontal axis 404 and a test value measured in direct current resistance (DCR) of a test battery cell in milliohms on a vertical axis 402. A first set of test values 406 are provided on a left portion of the graph 400 corresponding to a graphite anode including exclusively relatively high specific surface area graphite particles, and a second set of test values 408 are provided on a right portion of the graph 400 corresponding to a graphite anode including a blend of graphite particles as disclosed herein. Values upon the horizontal axis 404 for the first set of test values include zero cycles for a first test value 411A, 510 cycles for a second test value 412A, 1,020 cycles for a third test value 413A, 1,530 cycles for a fourth test value 414A, 2,040 cycles for a fifth test value 415A, and 2,550 cycles for a sixth test value 416A. Values upon the horizontal axis 404 for the second set of test values include zero cycles for a first test value 411B, 510 cycles for a second test value 412B, 1,020 cycles for a third test value 413B, 1,530 cycles for a fourth test value 414B, 2,040 cycles for a fifth test value 415B, and 2,550 cycles for a sixth test value 416B. The test results reveal that battery cell including the graphite anode including the blend of graphite particles as disclosed herein, including a blend of relatively high specific surface area graphite particles and relatively low specific surface area graphite particles, exhibit lower cell resistance, initially and after cyclic operation, as compared to the battery cell including the graphite anode including exclusively relatively high specific surface area graphite particles.

While the best modes for carrying out the disclosure have been described in detail, those familiar with the art to which this disclosure relates will recognize various alternative designs and embodiments for practicing the disclosure within the scope of the appended claims.

What is claimed is:

1. A solid-state battery system including a graphite anode, comprising:
a battery cell, including:
the graphite anode including a plurality of graphite particles, wherein the plurality of graphite particles includes:
a first portion of the plurality of graphite particles including a plurality of relatively high specific surface area graphite particles; and
a second portion of the plurality of graphite particles including a plurality of relatively low specific surface area graphite particles;
a cathode; and
a solid electrolyte layer disposed between the graphite anode and the cathode and operable to provide lithium-ion conduction paths between the graphite anode and the cathode.

2. The solid-state battery system of claim 1, wherein the plurality of the relatively high specific surface area graphite particles include a specific surface area of between 3.0 meters squared per gram and 5.0 meters squared per gram.

3. The solid-state battery system of claim 1, wherein the plurality of the relatively high specific surface area graphite particles include a specific surface area of 4.0 meters squared per gram.

4. The solid-state battery system of claim 1, wherein the plurality of the relatively low specific surface area graphite particles include a specific surface area of between 1.0 meters squared per gram and 2.0 meters squared per gram.

5. The solid-state battery system of claim 1, wherein the plurality of the relatively low specific surface area graphite particles include a specific surface area of 1.5 meters squared per gram.

6. The solid-state battery system of claim 1, wherein a ratio of the first portion to the second portion by weight is between 5:95 and 95:5.

7. The solid-state battery system of claim 1, wherein a ratio of the first portion to the second portion by weight is 1:1.

8. The solid-state battery system of claim 1, wherein the graphite anode further includes:
a first layer including the plurality of the relatively high specific surface area graphite particles; and
a second layer including the plurality of the relatively low specific surface area graphite particles; and
wherein the second layer is disposed between the first layer and the solid electrolyte layer.

9. The solid-state battery system of claim 1, wherein the graphite anode further includes:
a first layer including the plurality of the relatively high specific surface area graphite particles; and
a second layer including the plurality of the relatively low specific surface area graphite particles; and
wherein the first layer is disposed between the second layer and the solid electrolyte layer.

10. The solid-state battery system of claim 1, wherein the battery cell further includes a gel electrolyte which is operable to build up favorable lithium-ion conduction paths between solid-solid contacts in the graphite anode.

11. The solid-state battery system of claim 10, wherein a weight of the gel electrolyte is 10% of a total weight of the graphite anode.

12. The solid-state battery system of claim 10, wherein the solid electrolyte layer is one of an oxide-based solid electrolyte layer, a metal-doped solid electrolyte layer, an aliovalent-substituted oxide solid electrolyte layer, a sulfide-based solid electrolyte layer, a nitride-based solid electrolyte layer, a hydride-based solid electrolyte layer, a halide-based solid electrolyte layer, or a borate-based solid electrolyte layer.

13. The solid-state battery system of claim 10, wherein the cathode includes a cathode active material, solid electrolyte particles, a conductive additive, a binder, and a portion of the gel electrolyte.

14. The solid-state battery system of claim 13, wherein the cathode active material includes one of a rock salt layered oxide, a spinel, a polyanion cathode, a surface-coated cathode material, a doped cathode material, a lithiated metal oxide, a lithiate metal sulfide.

15. The solid-state battery system of claim 10, wherein the gel electrolyte includes a polymer host and a liquid electrolyte.

16. The solid-state battery system of claim 15, wherein the liquid electrolyte includes a lithium salt and a solvent; and
wherein the solvent includes one of a carbonate solvent, a lactone, a nitrile, a sulfone, an ether, a phosphate, or an ionic liquid.

17. The solid-state battery system of claim 1, further comprising a plurality of battery cells, wherein the battery cells are connected as one of a monopolar cell or a bipolar cell.

18. A solid-state battery system including a graphite anode, comprising:
a battery cell, including:
the graphite anode including a plurality of graphite particles, wherein the plurality of graphite particles includes:
a first portion of the plurality of graphite particles including a plurality of relatively high specific surface area graphite particles; and
a second portion of the plurality of graphite particles including a plurality of relatively low specific surface area graphite particles;
a cathode; and
a solid electrolyte layer disposed between the graphite anode and the cathode and operable to provide lithium-ion conduction paths between the graphite anode and the cathode; and
wherein the cathode and the anode each include solid electrolyte particles including one of an oxide-based solid electrolyte, a metal-doped solid electrolyte, an aliovalent-substituted oxide solid electrolyte, a sulfide-based solid electrolyte, a nitride-based solid electrolyte, a hydride-based solid electrolyte, a halide-based solid electrolyte layer, or a borate-based solid electrolyte;
wherein the cathode and anode each further include a conductive additive including one of carbon black, graphene, graphene oxide, acetylene black, carbon nanofibers, and carbon nanotubes; and
wherein the cathode and anode each further include a binder material including one of poly(vinylidene fluoride), poly(vinylidene fluoride-co-hexafluoropropylene), poly(tetrafluoroethylene), sodium carboxymethyl cellulose, styrene-butadiene rubber, nitrile butadiene rubber, and styrene ethylene butylene styrene copolymer.

19. A solid-state battery system including a graphite anode, comprising:
a battery cell, including:
the graphite anode including a plurality of graphite particles, wherein the plurality of graphite particles includes:
a first portion of the plurality of graphite particles including a plurality of relatively high specific surface area graphite particles; and
a second portion of the plurality of graphite particles including a plurality of relatively low specific surface area graphite particles;
a cathode; and
a solid electrolyte layer disposed between the graphite anode and the cathode and operable to provide lithium-ion conduction paths between the graphite anode and the cathode; and
wherein the graphite anode further includes an active material including one of a carbonaceous material, a silicon, a silicon mixed with graphite, or transition metal, a metal oxide, or a metal sulfide;
wherein the graphite anode further includes a conductive additive including one of carbon black, graphene, graphene oxide, acetylene black, carbon nanofibers, and carbon nanotubes; and
wherein the graphite anode further includes a binder material including one of poly(vinylidene fluoride), poly(vinylidene fluoride-co-hexafluoropropylene), poly(tetrafluoroethylene), sodium carboxymethyl cellulose, styrene-butadiene rubber, nitrile butadiene rubber, and styrene ethylene butylene styrene copolymer.
